(19) United States
(12) Patent Application Publication
(10) Pub. No.: US 2002/0107005 A1
(43) Pub. Date: Aug. 8, 2002

(54) Apparatus and method for notifyng a user of public place behavior in a mobile telecommunication system

(75) Inventor: Pil-Jun Kim, Inchon-kwangyokshi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/067,479

(22) Filed: Feb. 5, 2002

(30) Foreign Application Priority Data
Feb. 5, 2001 (KR) 5400/2001

(51) Int. Cl. H04M 3/42

(52) U.S. Cl. 455/414; 455/419; 455/422

(57) ABSTRACT

An apparatus and method for notifying a user of a mobile terminal of public place behavior in a mobile telecommunication system is provided. In the Public Place Behavior (PPB) notifying method, upon receipt of a message indicating entry into a public place from a message generator installed in the public place, the received message is displayed and a public place mode is set. If the message is not received from the message generator for a predetermined time period, the public place mode is released.

### PRIORITY

This application claims priority to an application entitled “Apparatus and Method for Notifying Manner Region in a Mobile Telecommunication System” filed in the Korean Industrial Property Office on Feb. 5, 2001 and assigned Serial No. 2001-5400, the contents of which are hereby incorporated by reference.

### BACKGROUND OF THE INVENTION

1. Field of the Invention

The present invention relates generally to a system and method for providing information to a user in a mobile telecommunication system, and in particular, to a system and method for providing information about a user's location to the user of a mobile terminal.

2. Description of the Related Art

In general, a mobile telecommunication system ensures mobility to a mobile terminal and enables communications, so that a terminal user can move freely, carrying the terminal with him. Despite the advantage of convenience, the mobility produces many problems. For example, indiscreet conversations on the phone in public can be annoying, while abrupt ringing of a mobile phone in a public place that requires silence as the proper behavior, like a library, theater or restaurant, may disturb other people.

To avoid such an annoying or irritating situation, a terminal can be set to a vibration mode or a public place mode. In other words, unless a user is considerate enough to do a mode change, he will make those around him crazy with his often-ringing phone and loud, annoying conversations.

In some places, phone calls or smoking is not allowed. In other places, taking photographs are forbidden, unauthorized admittance is denied, safety regulations must be kept, or no parking is allowed. Those warnings are typically provided by signposts or announced through speakers. If a user does not attend to the warnings, he may disturb many people around him, or place himself in trouble.

To meet the growing demands for more information via mobile terminals, a variety of services including voice service, text service, Internet service, etc. are provided to users. Yet, the present mobile terminal can afford to provide only user-requested services. Thus, there is a need for notifying a user of information about the proper behavior in a public place that he is inadvertently not aware of.

### SUMMARY OF THE INVENTION

It is, therefore, an object of the present invention to provide a system and method for notifying a user through a mobile terminal that he is situated in a public place or an etiquette-requiring place.

It is another object of the present invention to provide an apparatus and method for providing a message related with a public place to a mobile terminal.

It is a further object of the present invention to provide an apparatus and method for receiving a message related with a public place through a mobile terminal and providing the message to a user.

The foregoing and other objects of the present invention are achieved by providing an apparatus and method for notifying a user of public place behavior in a mobile telecommunication system. In the PPB (Public Place Behavior) notifying system, a message generator generates a message indicating entry into a predetermined public place, converts the message to a radio signal, and transmits the radio signal. A mobile terminal has a message receiver for receiving the radio signal from the message generator and converting the radio signal to data.

In the PPB notifying method, upon receipt of a message indicating entry into a public place from a message generator installed in the public place, the received message is displayed and a public place mode is set. If the message is not received from the message generator for a predetermined time period, the public place mode is released.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a mobile telecommunication system to which the present invention is applied;

FIG. 2 is a block diagram of a mobile terminal to which the present invention is applied; and

FIG. 3 is a flowchart illustrating a control operation for receiving a message in a mobile terminal according to the present invention.

### DETAILED DESCRIPTION OF THE PREFERRED EMBODIMENT

A preferred embodiment of the present invention will be described hereinbelow with reference to the accompanying drawings. In the following description, well-known functions or constructions are not described in detail since they would obscure the invention in unnecessary detail.

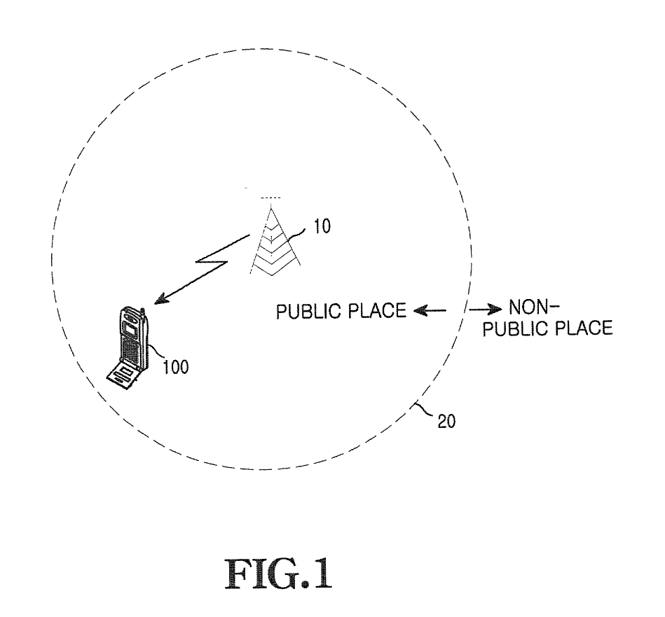

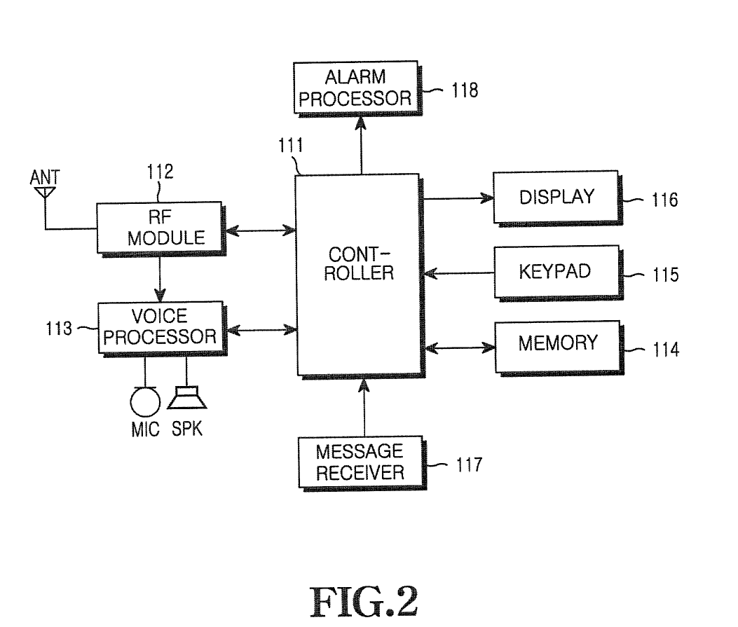

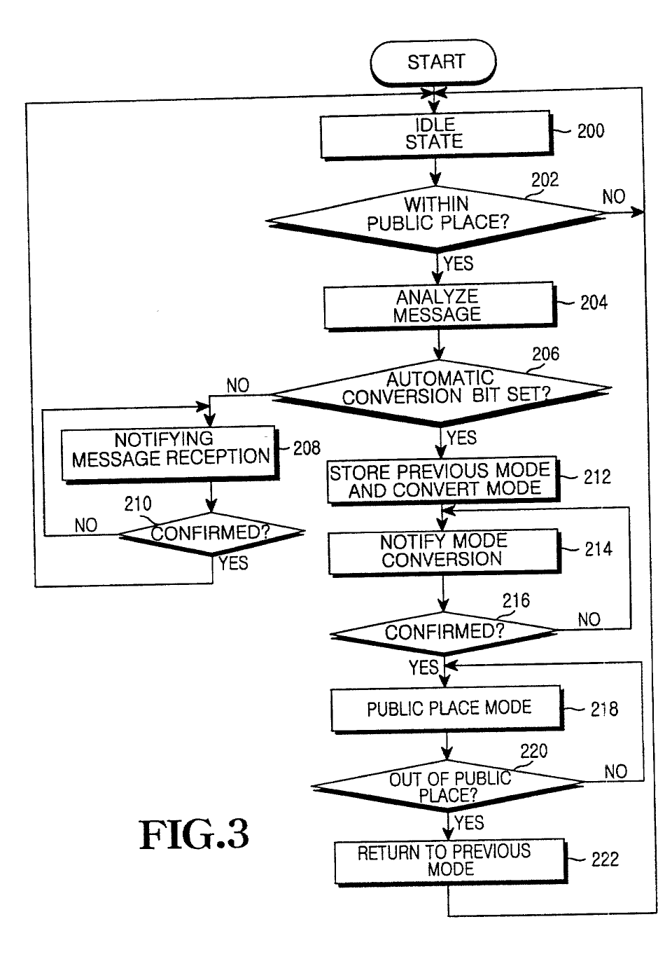

FIG. 1 illustrates the configuration of a mobile telecommunication system to which the present invention is applied. Referring to FIG. 1, a mobile terminal 100 is a wireless communication device such as a mobile phone, a cellular phone, or a PDA (Personal Digital Assistant). The mobile terminal 100 is provided with a public place message receiver or has a circuit modified to receive a public place message according to the present invention. The public place message receiver will be described in detail with reference to FIGS. 2 and 3 herein below.

A message generator 10 is installed in a public place and has a predetermined coverage area 20 like a base station in a mobile telecommunication system. Yet, the coverage area 20 of the message generator 10 is smaller than that of a base station. In a museum, for example, such a message generator covers the premises of the museum, or the museum and its surrounding area. The message generator 10 generates a message indicating that taking pictures are forbidden, like in a museum. When needed, the message generator 10 transmits the message along with an automatic vibration mode requesting signal.

The message generator 10 first generates a message related with a public place continuously or periodically, and transmits the message to a message receiver in a mobile terminal that has entered the public place 20. Each message generator 10 may generate a different message.

As stated above, when an automatic vibration mode requesting signal is necessary, the message is constructed to have a bit used to request automatic vibration mode conversion. Hereinafter, the bit will be referred to as an “automatic conversion bit”. While the automatic conversion bit is not limited to the vibration mode, it is assumed in the embodiment of the present invention that it indicates the vibration mode. The automatic conversion bit may be a single bit The message includes message fields and an independent field including the automatic conversion bit.

FIG. 2 is a block diagram of a mobile terminal to which the present invention is applied. Referring to FIG. 2, a controller 111 provides overall control to the mobile terminal, and upon receipt of a public place entry message, it notifies a user of the message reception according to the present invention. This message reception notification will be described referring to FIG. 3 herein below.

An RF (Radio Frequency) module 112 converts a radio signal received through an antenna ANT to a predetermined signal under the control of the controller 111 and feeds it to the controller 111 or a voice processor 113. Additionally, the RF module 112 converts a coded signal received from the voice processor 113 to a band radio signal for transmitting a radio signal in a predetermined band and outputs the band radio signal to the antenna ANT.

The signal transmitted from the RF module 112 to the controller 111 is a pilot signal/paging signal, data received during data communication, or a power control message received from the base station. The controller 111 also transmits data for call set-up, power control, or data needed in transmission data to the base station through the RF module 112. And the signal output from the RF module 112 to the voice processor is a coded voice signal received after call set-up.

The voice processor 113 decodes a signal received from the RF module 112, converts the decoded signal to an electrical voice signal, and outputs the voice signal through a speaker SPK under the control of the controller 111. The voice processor 113 also encodes an electrical voice signal received through a microphone MIC and transmits the coded signal to the RF module 112 under the control of the controller 111. According to the present invention, the voice processor 113 converts a voice signal received from a user through the speaker SPK to a digital coded signal in a speech recognition mode and feeds the digital signal to the controller 111.

A memory 114 can include a flash memory for temporarily storing data generated during a control operation in the controller 111 and a RAM (Random Access Memory) for storing data needed to control the mobile terminal and user input data. Therefore, the memory 114 stores control data according to the present invention.

A keypad 115 of a key matrix structure has digit keys for dialing and function keys for carrying out a variety of functions. Thus, the keypad 115 generates key signals corresponding to keys pressed by the user and feeds the signals to the controller 111. A display 116 displays the operational state of the mobile terminal, battery state, and a received signal strength indicator (RSSI). The display 116 also displays a message received from a message generator when the mobile terminal enters a public place according to the present invention.

A message receiver 117 receives the radio signal in the predetermined band and feeds it to the controller 111. This message receiver 117 can be incorporated in the RF module 112 or provided as a separate device as shown in FIG. 2. An alarm processor 118 has a motor for generating vibrations, a lamp for notifying message reception, or a melody generator for generating bell sounds to notify call origination or call termination. Upon receipt of a public place entry message as the mobile terminal enters a public place, the alarm processor 118 operates to notify the message, which will be described later in more detail.

FIG. 3 is a flowchart illustrating a control operation for message reception in a mobile terminal according to the present invention. Referring to FIG. 3, the controller 111 maintains an idle state in step 200. The idle state refers to a state where a paging signal is monitored and a pilot signal is received from a base station. In the idle state, the controller 111 additionally checks whether a key signal has been received from a user. According to the present invention, the controller 111 checks whether a public place entry message has been received from the message receiver 117 in the idle state in step 202. Upon receipt of the public place entry message, the controller goes step 204 and if the mobile terminal is not located in a public place, the controller 111 maintains the idle state in step 200.

If the mobile terminal 10 enters the coverage area 20 of the message generator 10 as shown in FIG. 1, the message receiver 117 converts the public place entry message received from the message generator 10 to predetermined data and transmits the data to the controller 111. Then, the controller 111 analyzes the public place entry message in step 204. That is, the controller 111 checks data to be displayed according to the received message and then determines whether the aforementioned automatic conversion bit is set in step 206. If the automatic conversion bit is set, the controller 111 goes to step 212 and if it is not set, the controller 111 goes to step 208.

In step 208, if the automatic conversion bit is not set, the controller 111 analyzes the received message from the message receiver 117 and displays the received message on the display 116 and then notifies reception of the message by controlling the alarm processor 118. The message reception can be notified in the same manner as reception of an SMS (Short Message Service) message, or in the same manner as call incoming in a vibration mode. Alternatively, the message reception can be notified in the same manner as reception of an SMS message in a mute mode or a public place mode.

The controller 111 checks whether the user has recognized the message reception notification in step 210. When a message is received in a mobile terminal, a user checks message reception by entering a predetermined key or opening a flip. If the user is aware of the message reception, the controller 111 goes to the idle state in step 200 and otherwise, it goes to step 208.

While the message reception is continuously notified in the embodiment of the present invention, if the mobile terminal comes out of the public place 20 of FIG. 1, the controller 111 may discontinue displaying the received message and control to enter the idle state in step 200.

Meanwhile, in step 212, if the automatic conversion bit is set, the controller 111 stores the previous mode in the memory 114 and transitions to a mode like an assumed vibration mode herein. The controller 111 displays the received message along with the mode conversion and notifies the mode conversion under the control of the alarm processor 118 in step 214. The mode conversion can be notified in the same manner used in step 208, or by vibrations. The mode conversion is continuously notified in step 214. In step 216, the controller 111 checks whether a confirmation signal has been received. The confirmation signal is identical to the signal used in step 210.

Upon receipt of the confirmation signal, the controller 111 goes to step 216 and if the confirmation signal is not received, the controller 111 maintains step 214. If the mobile terminal 10 moves out of the public place 20 before the confirmation signal is received, step 222 can be performed.

In step 218, the controller 111 sets a public place mode. The public place mode refers to a vibration mode or a public place mode as described before. The controller 111 also discontinues displaying the message on the display 116 and displays an icon image indicating a normal state or a public place entry state. In step 220, the controller 111 determines whether the mobile terminal 10 is out of the public place 20. Outside the public place 20, the controller 111 goes to step 222 and inside the public place 20, it maintains step 218.

The controller 111 checks whether the mobile terminal 10 is out of the public place 20 in a different manner according to the configuration of the message generator 10. If the message generator 10 is so constituted that it transmits a signal continuously, the controller 111 determines that the mobile terminal 10 is out of the public place 20 when no messages have been received from the message generator 10 for a predetermined period. For example, if the period is 10 seconds and no message reception occurs three times, the controller 111 concludes that the mobile terminal 10 is out of the public place 20. The period and number of non-message reception occurrences are optimized empirically considering geographical characteristics.

In step 222, the controller 111 returns to the previous mode referring to the data stored in the memory 114. Whether to notify the previous mode to the user or not is implementation-dependent. Then, the controller 111 returns to step 200.

In accordance with the present invention as described above, a message generator is installed in a public place in a mobile communication system. Therefore, entry into or movement out of the public place is notified to a user through a mobile terminal. If the mobile terminal is in a public place, mode transition occurs automatically, to thereby reduce indiscreet phone call-caused annoying situations.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A Public Place Behavior (PPB) notifying system in a mobile communication system, comprising:
a message generator for generating a message indicating entry into a predetermined public place, converting the message to a radio signal, and transmitting the radio signal; and
a mobile terminal having a message receiver for receiving the radio signal from the message generator and converting the radio signal to data.

2. The PPB notifying system of claim 1, wherein the message includes a message field indicating entry of the mobile terminal into a public place, and an automatic conversion field requesting mode conversion.

3. The PPB notifying system of claim 1, wherein the mobile terminal comprises:
a display for notifying a user of the mobile terminal of entry into the predetermined public place when the mobile terminal enters the public place; and
an alarm processor for notifying of mode conversion.

4. The PPB notifying system of claim 2, wherein the mobile terminal comprises:
a display for notifying a user of the mobile terminal of entry into the predetermined public place when the mobile terminal enters the public place; and
an alarm processor for notifying of mode conversion.

5. A mobile terminal for receiving a signal from a message generator installed in a public place and processing the signal, comprising:
a message receiver for converting the received signal to a digital signal by band conversion;
a controller for analyzing the output of the message receiver and controlling display of the received message; and
a display for displaying the received message under control of the controller.

6. The mobile terminal of claim 5, further comprising an alarm processor for generating an alarm signal under the control of the controller;
wherein the controller notifies a user of entry into a public place.

7. The mobile terminal of claim 5, wherein the controller clears the message from the display when the mobile terminal moves out of the public place.

8. The mobile terminal of claim 6, wherein the controller clears the message from the display when the mobile terminal moves out of the public place.

9. The mobile terminal of claim 5, wherein the controller clears the message from the display when a confirmed signal is received from a user.

10. The mobile terminal of claim 6, wherein the controller clears the message from the display when a confirmed signal is received from the user.

11. A mobile terminal for receiving a predetermined signal from a message generator installed in a public place and processing the signal, comprising:
a message receiver for converting the received signal to a digital signal by band conversion;
a controller for analyzing a message output from the message receiver, storing a previous mode and setting the mobile terminal to a vibration mode if an automatic conversion bit is set in the message, and displaying the message if the automatic conversion bit is not set;
a display for displaying the received message under the control of the controller; and
an alarm processor for notifying a user of the mode conversion.

12. The mobile terminal of claim 11, wherein the controller clears the message from the display when the mobile terminal moves out of the public place.

13. The mobile terminal of claim 11, wherein the controller clears the message from the display when a confirmed signal is received from a user.

14. The mobile terminal of claim 12, wherein the controller clears the message from the display when a confirmed signal is received from a user.

15. A Public Place Behavior (PPB) notifying method for a mobile terminal having a message receiver for receiving a predetermined signal from a message generator installed in a public place and performing band conversion on the received signal, the method comprising the steps of:
displaying a message upon receipt of the signal indicating entry into the public place from the message receiver, and setting a public place mode; and
releasing the public place mode if the signal is not received from the message generator for a predetermined time period.

16. The PPB notifying method of claim 15, further comprising the steps of:
checking an automatic conversion bit in the signal, storing a previous mode if the automatic conversion bit is set, and transitioning to the public place mode; and
displaying the message and notifying a user of transition to the public place mode through an alarm processor.

17. The PPB notifying method of claim 15, further comprising the step of discontinuing display of the message upon receipt of a confirmed signal during displaying the message.

18. The PPB notifying method of claim 16, further comprising the step of discontinuing display of the message upon receipt of a confirmed signal during displaying the message.
